(19) United States
(12) Patent Application Publication
(10) Pub. No.: US 2017/0175042 A1
(43) Pub. Date: Jun. 22, 2017

(54) STRUCTURED DETERGENT COMPOSITIONS

(71) Applicant: The Procter & Gamble Company, Cincinnati, OH (US)

(72) Inventors: Deepak AHIRWAL, Brussels (BE); Susana FERNANDEZ - PRIETO, Benicassim (ES); Vincenzo GUIDA, Woluwe Saint Pierre (BE); Bruno Jean-Pierre MATTHYS, Brussels (BE); Joris MEERT, Bambrugge (BE); Johan SMETS, Lubbeek (BE); Evelyne Johanna Lutgarde VAN HECKE, Bachte - Maria - Leerne (BE); Laure WAEGEMANS, Neder-over-Heembeek (BE)

(21) Appl. No.: 15/367,215

(22) Filed: Dec. 2, 2016

(30) Foreign Application Priority Data
Dec. 22, 2015 (EP) 15201805.7
Oct. 24, 2016 (EP) 16195199.1

(51) Int. Cl. C11D 3/382; C11D 3/37; C11D 1/83; C11D 11/00; C11D 1/66; C11D 1/22; C11D 17/00

(52) U.S. Cl. CPC C11D 3/382; C11D 1/22; C11D 3/3773; C11D 17/0026; C11D 11/0017; C11D 1/66; C11D 1/83; C11D 17/0039

(57) ABSTRACT

The need for a structurant system which is effective at providing improved structuring of a wide variety of actives, while also providing a liquid detergent composition having improved translucency is met through a combination of a non-polymeric, crystalline, hydroxyl-containing rheology modifier and an acrylate derivative rheology modifier.

### FIELD OF THE INVENTION

Structured detergent compositions having improved translucency and physical stability.

### BACKGROUND OF THE INVENTION

Aqueous structurant premixes comprising a non-polymeric, crystalline, hydroxyl-containing structuring agent, such as hydrogenated castor oil, have been used to structure and thicken liquid compositions. While the non-polymeric, crystalline, hydroxyl-containing structuring agent can be melted and directly dispersed into a liquid composition, the structuring agent is usually first formed into a premix in order to both improve processibility, and to improve structuring efficacy. Hence, the molten structuring agent is generally first emulsified in water, and then crystallised to form a premix of the non-polymeric, crystalline, hydroxyl-containing rheology modifier. The resultant premix of the non-polymeric, crystalline, hydroxyl-containing rheology modifier is then added to a liquid composition (see for example, WO2011031940). Such structurants have been highly effective at structuring liquid detergent compositions. However, structurants derived from non-polymeric, crystalline, hydroxyl-containing structuring agents have typically been highly opaque.

In recent years, liquid detergent compositions, for use around the household, have increased in complexity, comprising a wide variety of polymers, and particulates, such as deposition aids, soil release polymers, microcapsules, perfume droplets and other oils, in addition to typical ingredients such as surfactants. Such additives provide a variety of benefits, such as better stain removal and stain repellence, care benefits such as fabric softening, improved aesthetics, and longer lasting freshness. The result is a liquid detergent composition with a complex balance of hydrophilic and hydrophobic ingredients. Changes in formulation, and even level changes arising from process variation, result in changes in the hydrophilic-hydrophobic balance as well as changes in the ionic strength. As a result, the amount of structurant that needs to be added has varied as ingredients have been added and removed. Moreover, it has become increasingly challenging to structure the wide variety of these active ingredients in the liquid detergent composition, especially in low water formulae.

Therefore, a need remains for a structurant system which is effective at providing improved structuring of a wide variety of actives, while also providing a liquid detergent composition having improved translucency.

EP1220886 relates to liquid cleansing compositions in lamellar phase which possess a lotion-like. EP1328616 relates to structuring systems, specifically thread-like structuring systems and/or disk-like structuring systems wherein structuring agents aggregate together to form disk-like structures that can interact with other disk-like structures to result in a structuring system, and processes for making such structuring systems, stabilized liquid detergent compositions comprising such structuring systems, systems that utilize such structuring systems for stabilizing liquid detergent compositions, and methods for utilizing the stabilized liquid detergent compositions to provide a benefit. U.S. Pat. No. 5,977,036 relates to hair styling shampoo compositions which comprise from about 5% to about 50% by weight of a surfactant selected from the group consisting of anionic surfactants, zwitterionic or amphoteric surfactants having an attached group that is anionic at the pH of the composition, and combinations thereof; from about 0.025% to about 3% by weight of an organic cationic polymer having a cationic charge density of from about 0.2 meq/gm to about 7 meq/gm and a molecular weight of from about 5,000 to about 10 million; from about 0.1% to about 10% by weight of a water-insoluble hair styling polymer;

from about 0.1% to about 10% by weight of a water-insoluble volatile solvent; and from about 0.005% to about 2.0% by weight a crystalline hydroxyl-containing stabilizing agent; and from about 26.5% to about 94.9% by weight water. US2005020321 relates to a pourable cleaning composition comprising a plurality of stably suspended, visibly distinct beads, and at least two structurants selected from different groups of structurant. EP2711414 relates to stabilizing systems for capsules in laundry detergents and other cleaning products, comprise at least one rheology modifier consisting of hardened castor oil, hardened castor waxes, polyacrylates and/or layered silicates.

### SUMMARY OF THE INVENTION

The present invention relates to a liquid detergent composition comprising: a non-polymeric, crystalline, hydroxyl-containing rheology modifier; an acrylate derivative rheology modifier, as described in present claim 1.

The present invention further relates to the use of a combination of a non-polymeric, crystalline, hydroxyl-containing rheology modifier and an acrylate derivative rheology modifier, as described herein, to provide a composition, particularly a laundry detergent composition, having improved translucency.

### DETAILED DESCRIPTION OF THE INVENTION

The compositions structured using a combination of the non-polymeric, crystalline, hydroxyl-containing rheology modifier and the acrylate derivative rheology modifier provide improved translucency. As such, the compositions of the present invention can provide a reflectance profile of between 0.7 to 10% on average in the visible light spectrum (400 to 700 nm) and a transmittance profile of between 48 and 88% on average in the visible light spectrum (400 to 700 nm). More preferably, the composition has a reflectance profile of between 1.5 and 5.9% on average in the visible light spectrum (400 to 700 nm) and a transmittance profile of between 64 and 79% on average in the visible light spectrum (400 to 700 nm). Most preferably, the composition has a reflectance profile of between 3.4 and 5.3% on average in the visible light spectrum (400 to 700 nm) and a transmittance profile between 68 and 75% on average in the visible light spectrum (400 to 700 nm).

As used herein, “liquid composition” refers to any composition which is liquid in form. The composition can include solids or gases in suitably subdivided form, but the overall composition excludes product forms which are non-liquid overall, such as tablets or granules. The liquid detergent composition can take any suitable form such as a liquid laundry detergent, unit dose detergent or hard surface cleaning compositions. Preferred liquid detergent compositions are liquid laundry detergent compositions. The liquid detergent compositions preferably have densities in the range from 0.9 to 1.3 grams per cubic centimeter, more specifically from 1.00 to 1.10 grams per cubic centimeter, excluding any solid additives and bubbles, if present.

All percentages, ratios and proportions used herein are by weight percent of the composition, unless otherwise specified. All average values are calculated “by weight” of the composition or components thereof, unless otherwise expressly indicated.

Liquid Detergent Composition:

The liquid detergent composition comprises a crystalline, hydroxyl-containing structuring agent with an acrylate derivative rheology modifier, surfactant, and water.

Non-Polymeric, Crystalline, Hydroxyl-Containing Structuring Agent

The composition comprises a non-polymeric, crystalline, hydroxyl-containing structuring agent. The non-polymeric (except for conventional alkoxylation), crystalline hydroxy-functional materials form a thread-like structuring system throughout the liquid matrix when they are crystallized within the matrix in situ, or as part of a premix. Such materials can be generally characterized as crystalline, hydroxyl-containing fatty acids, fatty esters or fatty waxes. Such materials will generally be selected from those having the following formulas:

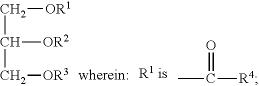

R² is R¹ or H; R³ is R¹ or H; R⁴ is independently C10-C22 alkyl or alkenyl comprising at least one hydroxyl group;

They can be more particularly defined by the following formula:

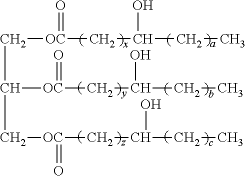

wherein:

(x+a) is from between 11 and 17;

(y+b) is from between 11 and 17; and

(z+c) is from between 11 and 17.

Preferably, in this formula x=y=z=10 and/or a=b=c=5.

Specific examples of preferred crystalline, hydroxyl-containing rheology modifiers include castor oil and its derivatives. Especially preferred are hydrogenated castor oil derivatives such as hydrogenated castor oil (HCO), hydrogenated castor wax, and ethane-1,2-diyl bis(12-hydroxyoctadecanoate). Commercially available, castor oil-based, crystalline, hydroxyl-containing rheology modifiers include THIXCIN® R from Rheox, Inc. (now Elementis). Further examples of useful HCO may be found in U.S. Pat. No. 5,340,390.

HCO as used herein most generally can be any hydrogenated castor oil or derivative thereof, provided that it is capable of crystallizing in the non-polymeric crystalline, hydroxy-functional structurant premix. Castor oils may include glycerides, especially triglycerides, comprising C₁₀ to C₂₂ alkyl or alkenyl moieties which incorporate a hydroxyl group. Hydrogenation of castor oil, to make HCO, converts the double bonds which may be present in the starting oil as ricinoleyl moieties. As such, the ricinoleyl moieties are converted into saturated hydroxyalkyl moieties, e.g., hydroxystearyl. The HCO herein may, in some embodiments, be selected from: trihydroxystearin; dihydroxystearin; and mixtures thereof. The HCO may be processed in any suitable starting form, including, but not limited to those selected from solid, molten and mixtures thereof. HCO is typically present at a level of from 2% to 10%, from 3% to 8%, or from 4% to 6% by weight in the structuring premix. In some embodiments, the corresponding percentage of hydrogenated castor oil delivered into a final composition is below 1.0%, typically from 0.05% to 0.8%.

Particularly suitable non-polymeric crystalline, hydroxyl-containing rheology modifiers have the following characteristics: a melting point of from 40° C. to 120° C., or from 65° C. to 95° C.; and/or Iodine value ranges of from 0 to 5, from 0 to 4, or from 0 to 2.6. The melting point of HCO can measured using either ASTM D3418 or ISO 11357; both tests utilize DSC: Differential Scanning Calorimetry.

All of these non-polymeric crystalline, hydroxyl-containing rheology modifiers as hereinbefore described are believed to function by forming thread-like structuring systems when they are crystallized in situ within the aqueous liquid matrix of the compositions herein or within a pre-mix which is used to form such an aqueous liquid matrix. Such crystallization is brought about by heating an aqueous mixture of these materials to a temperature above the melting point of the rheology modifier, followed by cooling of the mixture to room temperature while maintaining the liquid under agitation.

Under certain conditions, the crystalline, hydroxyl-containing rheology modifiers will, upon cooling, form the thread-like structuring system within the aqueous liquid matrix. This thread-like system can comprise a fibrous or entangled thread-like network. Non-fibrous particles in the form of “rosettas” may also be formed. The particles in this network can have an aspect ratio of from 1.5:1 to 200:1, more preferably from 10:1 to 200:1. Such fibers and non-fibrous particles can have a minor dimension which ranges from 1 micron to 100 microns, more preferably from 5 microns to 15 microns. The aspect ratio is the average particles' length (1) relative to the widest cross sectional particles' width (d).

These crystalline, hydroxyl-containing materials are especially preferred rheology modifiers for providing the detergent compositions herein with shear-thinning rheology. These materials and the networks they form also serve to stabilize the compositions herein against liquid-liquid or solid-liquid phase separation. Their use thus permits the formulator to use less of relatively expensive non-aqueous solvents or phase stabilizers which might otherwise have to be used in higher concentrations to minimize undesirable phase separation. These preferred crystalline, hydroxyl-containing rheology modifiers are described in detail in U.S. Pat. No. 6,080,708 and in WO 02/40627.

Anionic surfactant may be present in the premix of the non-polymeric crystalline, hydroxy-functional structurant agent, in order to improve the emulsification of the non-polymeric, crystalline, hydroxyl-containing structuring agent. Without wishing to be bound by theory, it is believed that the anionic surfactant acts as an emulsifier of melts of HCO and other crystallizable glycerides. Any suitable anionic surfactant is of use with the non-polymeric crystalline, hydroxy-functional structurant. Non-limiting examples of suitable anionic surfactants of use herein include: Linear Alkyl Benzene Sulphonate (LAS), Alkyl Sulphates (AS), Alkyl Ethoxylated Sulphonates (AES), Laureth Sulfates and mixtures thereof. In some embodiments, the anionic surfactant may be present in the premix at a level of from 5% to 50% by weight of the premix. Note however, that when using more than 25% by weight of the structurant system, of an anionic surfactant, it is typically required to thin the surfactant using a non-aminofunctional organic solvent in addition to water.

The anionic surfactants are typically present in the form of their salts with alkanolamines or alkali metals such as sodium and potassium. Preferably, the anionic emulsifiers are neutralized with alkanolamines such as monoethanolamine or triethanolamine, and are fully soluble in the liquid phase of the external structuring system.

The non-polymeric crystalline, hydroxy-functional structurant premix generally comprises water, at levels of from 5% to 90%, preferably from 10% to 85%, more preferably from 30% to 80% by weight water. However organic non-aminofunctional organic solvents, typically consisting essentially of C, H and O (i.e., non-silicones and heteroatom-free) may also be present in the non-polymeric crystalline, hydroxy-functional structurant as solvents to help control or reduce viscosity, especially during processing.

Acrylate Derivative Rheology Modifier

The acrylate derivative rheology modifier has the following formula:

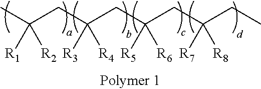

wherein:
   i. a, b, c and d are integers from 0 to 4,000 and the sum of all integers in rheology modifier 1 is an integer from about 60 to about 7,000;
   ii. R₁, R₃, R₅ and R₇ are independently selected from the group consisting of: —H, —CH₃
   iii. R₈ is a ester moiety having the formula

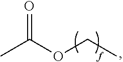

wherein f is an integer from 3 to 7; Preferably, f=3 (butyl ester), in order to provide an improved balance between the hydrophobic connection with the non-polymeric, crystalline, hydroxyl-containing rheology modifier and solubility of the hydrophobic group linking with the non-polymeric, crystalline, hydroxyl-containing rheology modifier to build the network; The acrylate derivative rheology modifier comprises at least 30% by mol, preferably at least 40% by mol, more preferably at least 50% by mol of R₈.
iv. R₂, R₄ and R₆ are independently selected from the group consisting of:

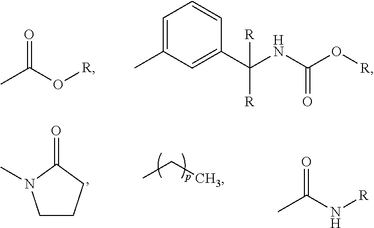

wherein p is an integer from 0 to 45, and R is independently selected from the group consisting of:

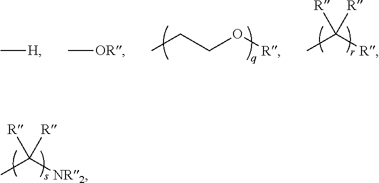

wherein each q and r and s is independently an integer from 0 to 45, and each R″ is independently selected from the group consisting of:

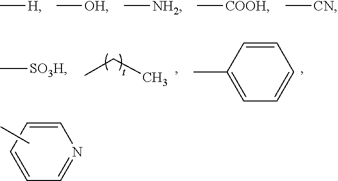

wherein t is an integer from 0 to 40; and
v. the polymeric structuring agent has a molecular weight of from 50,000 Da to 2,000,000 Da, from 100,000 Da to 1,000,000 Da, or even from 500,000 Da to 900,000 Da
In a preferred embodiment, R₂, R₄ and R₆ are

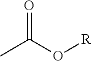

wherein R is independently selected from the group consisting of:

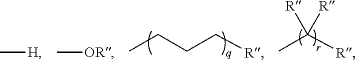

wherein each q and r and s is independently an integer from 0 to 45, preferably 1 to 40, even more preferred 20 to 35 and each R″ is independently selected from the group consisting of:

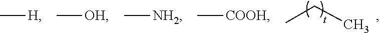

wherein t is an integer from 0 to 40, preferably from 1 to 20.
R₂, R₄ and R₆ can be different or the same. The acrylate derivative rheology modifier can comprise less than 30% by mol, preferably below 25% by mol of carboxylic acid groups as R₂, R₄ and/or R₆. The acrylate derivative rheology modifier can comprise less than 50% by mol, preferably less than 40% by mol, more preferably less than 30% by mol of ethyl ester groups as R₂, R₄ and/or R₆.

Preferably, the acrylate derivative rheology modifier is present at a level of from 0.01 wt % to 1.2 wt %, more preferably 0.05 wt % to 0.8 wt %, most preferably 0.1 wt % to 0.5 wt % of the composition

It has surprisingly been found that a combination of the acrylate derivative rheology modifier having the structure of Polymer 1, with a non-polymeric, crystalline, hydroxyl-containing structuring agent, provides improved translucency and physical stability, over a combination of non-polymeric, crystalline, hydroxyl-containing structuring agent with other acrylate-derived thickeners.

Suitable acrylate derivative rheology modifiers include Novethix™ HC200 (supplied by Lubrizol) and Rheovis™ AT-120 (supplied by BASF).

Surfactant:

The composition comprises surfactant. The surfactant is preferably present at a level of from 1 wt % to 70 wt %, more preferably 2 wt % to 50 wt %, more preferably from 5 wt % to 40 wt %, most preferably from 12 wt % to 30 wt % of the composition

The surfactant can be selected from the group consisting of: anionic surfactant, nonionic surfactant, and mixtures thereof.

Suitable anionic surfactants can be selected from the group consisting of: alkyl sulphates, alkyl ethoxy sulphates, alkyl sulphonates, alkyl benzene sulphonates, fatty acids and their salts, and mixtures thereof. However, by nature, every anionic surfactant known in the art of detergent compositions may be used, such as disclosed in “Surfactant Science Series”, Vol. 7, edited by W. M. Linfield, Marcel Dekker. However, the composition preferably comprises at least a sulphonic acid surfactant, such as a linear alkyl benzene sulphonic acid, but water-soluble salt forms may also be used. Anionic surfactant(s) are typically present at a level of from 0 wt % to 19 wt %, preferably from 2 wt % to 16 wt %, and more preferably from 5 wt % to 14 wt % of the composition.

Anionic sulfonate or sulfonic acid surfactants suitable for use herein include the acid and salt forms of linear or branched C5-C20, more preferably C10-C16, more preferably C11-C13 alkylbenzene sulfonates, C5-C20 alkyl ester sulfonates, C6-C22 primary or secondary alkane sulfonates, C5-C20 sulfonated polycarboxylic acids, and any mixtures thereof, but preferably C11-C13 alkylbenzene sulfonates. The aforementioned surfactants can vary widely in their 2-phenyl isomer content.

Anionic sulphate salts suitable for use in the compositions of the invention include the primary and secondary alkyl sulphates, having a linear or branched alkyl or alkenyl moiety having from 9 to 22 carbon atoms or more preferably 12 to18 carbon atoms. Also useful are beta-branched alkyl sulphate surfactants or mixtures of commercial available materials, having a weight average (of the surfactant or the mixture) branching degree of at least 50%.

Mid-chain branched alkyl sulphates or sulfonates are also suitable anionic surfactants for use in the compositions of the invention. Preferred mid-chain branched alkyl sulphates or sulfonates are the C5-C22, preferably C10-C20 mid-chain branched alkyl primary sulphates. When mixtures are used, a suitable average total number of carbon atoms for the alkyl moieties is preferably within the range of from greater than 14.5 to 17.5. Preferred mono-methyl-branched primary alkyl sulphates are selected from the group consisting of the 3-methyl to 13-methyl pentadecanol sulphates, the corresponding hexadecanol sulphates, and mixtures thereof. Dimethyl derivatives or other biodegradable alkyl sulphates having light branching can similarly be used.

Other suitable anionic surfactants for use herein include fatty methyl ester sulphonates and/or alkyl ethoxy sulphates (AES) and/or alkyl polyalkoxylated carboxylates (AEC). Mixtures of anionic surfactants can be used, for example mixtures of alkylbenzenesulphonates and AES.

The anionic surfactants are typically present in the form of their salts with alkanolamines or alkali metals such as sodium and potassium.

The composition preferably comprises fatty acids, fatty acid salts, and mixtures thereof. Preferably, the composition comprises from 0.1 wt % to 10 wt %, more preferably from 0.5 wt % to 4 wt % of fatty acid, fatty acid salts, and mixtures thereof.

The composition preferably comprises a nonionic surfactant. Preferably, the composition comprises up to 40 wt %, more preferably from 0 wt % to 30 wt %, most preferably from 1 wt % to 15 wt % of non-ionic surfactant.

Suitable nonionic surfactants include, but are not limited to C12-C18 alkyl ethoxylates (“AE”) including the so-called narrow peaked alkyl ethoxylates and C6-C12 alkyl phenol alkoxylates (especially ethoxylates and mixed ethoxy/propoxy), block alkylene oxide condensate of C6-C12 alkyl phenols, alkylene oxide condensates of C8-C22 alkanols and ethylene oxide/propylene oxide block polymers (Pluronic—BASF Corp.), as well as semi polar nonionics (e.g., amine oxides and phosphine oxides) can be used in the present compositions. An extensive disclosure of these types of surfactants is found in U.S. Pat. No. 3,929,678, Laughlin et al., issued Dec. 30, 1975.

Alkylpolysaccharides such as disclosed in U.S. Pat. No. 4,565,647 Llenado are also useful nonionic surfactants in the compositions of the invention.

Also suitable are alkyl polyglucoside surfactants.

In some embodiments, nonionic surfactants of use include those of the formula R₁(OC₂H₄)ₙOH, wherein R₁ is a C10-C16 alkyl group or a C8-C12 alkyl phenyl group, and n is from preferably 3 to 80. In some embodiments, the nonionic surfactants may be condensation products of C12-C15 alcohols with from 5 to 20 moles of ethylene oxide per mole of alcohol, e.g., C12-C13 alcohol condensed with 6.5 moles of ethylene oxide per mole of alcohol

Additional suitable nonionic surfactants include polyhydroxy fatty acid amides of the formula:

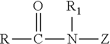

wherein R is a C9-17 alkyl or alkenyl, R1 is a methyl group and Z is glycidyl derived from a reduced sugar or alkoxylated derivative thereof. Examples are N-methyl N-1-deoxyglucityl cocoamide and N-methyl N-1-deoxyglucityl oleamide. Processes for making polyhydroxy fatty acid amides are known and can be found in Wilson, U.S. Pat. No. 2,965,576 and Schwartz, U.S. Pat. No. 2,703,798.

The composition can comprise addition surfactants, including those selected from the group consisting of: amphoteric and/or zwitterionic surfactants, cationic surfactants, semi-polar surfactants, and mixtures thereof.

Suitable amphoteric or zwitterionic detersive surfactants include those which are known for use in hair care or other personal care cleansing. Non-limiting examples of suitable zwitterionic or amphoteric surfactants are described in U.S. Pat. No. 5,104,646 (Bolich Jr. et al.), U.S. Pat. No. 5,106,609 (Bolich Jr. et al.). Suitable amphoteric detersive surfactants include those surfactants broadly described as derivatives of aliphatic secondary and tertiary amines in which the aliphatic radical can be straight or branched chain and wherein one of the aliphatic substituents contains from 8 to 18 carbon atoms and one contains an anionic group such as carboxy, sulfonate, sulfate, phosphate, or phosphonate. Suitable amphoteric detersive surfactants for use in the present invention include, but are not limited to: cocoamphoacetate, cocoamphodiacetate, lauroamphoacetate, lauroamphodiacetate, and mixtures thereof.

Suitable zwitterionic detersive surfactants are well known in the art, and include those surfactants broadly described as derivatives of aliphatic quaternary ammonium, phosphonium, and sulfonium compounds, in which the aliphatic radicals can be straight or branched chain, and wherein one of the aliphatic substituents contains from 8 to 18 carbon atoms and one contains an anionic group such as carboxy, sulfonate, sulfate, phosphate or phosphonate. Zwitterionics such as betaines are suitable for the composition.

Suitable semi-polar surfactants include amine oxide surfactants. Amine oxide surfactants having the formula: R(EO)x(PO)y(BO)zN(O)(CH2R′)2.qH2O (I) are particularly useful in the composition of the present invention. R is a relatively long-chain hydrocarbyl moiety which can be saturated or unsaturated, linear or branched, and can contain from 8 to 20, preferably from 10 to 16 carbon atoms, and is more preferably C12-C16 primary alkyl. R′ is a short-chain moiety preferably selected from hydrogen, methyl and —CH2OH. When x+y+z is different from 0, EO is ethyleneoxy, PO is propyleneneoxy and BO is butyleneoxy. Amine oxide surfactants are illustrated by C12-14 alkyldimethyl amine oxide.

Non-limiting examples of other anionic, zwitterionic, amphoteric or optional additional surfactants suitable for use in the compositions are described in McCutcheon's, Emulsifiers and Detergents, 1989 Annual, published by M. C. Publishing Co., and U.S. Pat. Nos. 3,929,678, 2,658,072; 2,438,091; 2,528,378.

Optional Ingredients:

Since compositions structured using a combination of the non-polymeric, crystalline, hydroxyl-containing rheology modifier and acrylate derivative rheology modifier of formula I provide improved translucency, they are particularly suited for comprising microcapsules, droplets, particles, visible bubbles, and mixtures thereof. Suitable levels of such ingredients are from 0.0001% to 5%, or from 0.1% to 1% by weight of the liquid detergent composition.

Microcapsules are typically formed by at least partially, preferably fully, surrounding a benefit agent with a wall material. Suitable benefit agents can be selected from to group consisting of: a perfume, a silicone, a biocontrol agent, an antimicrobial agent, a heating or cooling agent, a drug, a sun screen, a skin benefit agents such as paraffin and petrolatum, hueing dyes, enzymes, brighteners, a malodor control technology, and mixtures thereof. Preferably, the microcapsule is a perfume microcapsule, where said benefit agent comprises one or more perfume raw materials.

The microcapsule wall material may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, resorcinol-based materials, poly-isocyanate-based materials, acetals (such as 1,3,5-triol-benzene-gluteraldehyde and 1,3,5-triol-benzene melamine), starch, cellulose acetate phthalate and mixtures thereof.

Suitable melamine wall material comprises melamine crosslinked with formaldehyde, melamine-dimethoxyethanol crosslinked with formaldehyde, and mixtures thereof.

Suitable polyacrylate wall material comprises one or more multifunctional acrylate moieties; preferably said multifunctional acrylate moiety being selected from the group consisting of tri-functional acrylate, tetra-functional acrylate, penta-functional acrylate, hexa-functional acrylate, hepta-functional acrylate and mixtures thereof; and optionally a polyacrylate that comprises a moiety selected from the group consisting of an amine acrylate moiety, methacrylate moiety, a carboxylic acid acrylate moiety, carboxylic acid methacrylate moiety and combinations thereof.

The perfume microcapsule may be coated with a deposition aid, a cationic polymer, a non-ionic polymer, an anionic polymer, or mixtures thereof. Suitable polymers may be selected from the group consisting of: polyvinylformaldehyde, partially hydroxylated polyvinylformaldehyde, polyvinylamine, polyethyleneimine, ethoxylated polyethyleneimine, polyvinylalcohol, polyacrylates, chitosan and chitosan derivatives and combinations thereof.

Where the perfume microcapsules are coated with a deposition aid, it has been discovered that the deposition aid results in reduced physical stability of compositions structured using the non-polymeric, crystalline, hydroxyl-containing rheology modifier alone. It has further been discovered that the addition of the acrylate derivative rheology modifier of formula I significantly improves the physical stability of compositions which comprise the perfume microcapsule coated with a deposition aid and the non-polymeric, crystalline, hydroxyl-containing rheology modifier.

Preferably, the perfume microcapsules have a volume weighted mean particle size from 0.1 microns to 100 microns, preferably from 0.5 microns to 60 microns.

Especially where the composition comprises microcapsules having a shell formed at least partially from formaldehyde, the liquid detergent composition can additionally comprise one or more sulfur-based or non-sulfur-based formaldehyde scavengers.

The non-sulfur based formaldehyde scavenger is preferably selected from the group consisting of urea, ethylene urea, lysine, glycine, serine, carnosine, histidine, 3,4-diaminobenzoic acid, allantoin, glycoluril, anthranilic acid, methyl anthranilate, methyl 4-aminobenzoate, ethyl acetoacetate, acetoacetamide, malonamide, ascorbic acid, 1,3-dihydroxyacetone dimer, biuret, oxamide, benzoguanamine, pyroglutamic acid, pyrogallol, methyl gallate, ethyl gallate, propyl gallate, triethanol amine, succinamide, benzotriazol, triazole, indoline, oxamide, sorbitol, glucose, cellulose, poly(vinyl alcohol), partially hydrolyzed poly(vinylformamide), poly(vinyl amine), poly(ethylene imine), poly(oxyalkyleneamine), poly(vinyl alcohol)-co-poly(vinyl amine), poly(4-aminostyrene), poly(l-lysine), chitosan, hexane diol, ethylenediamine-N,N′-bisacetoacetamide, N-(2-ethylhexyl)acetoacetamide, 2-benzoylacetoacetamide, N-(3-phenylpropyl) acetoacetamide, lilial, helional, melonal, triplal, 5,5-dimethyl-1,3-cyclohexanedione, 2,4-dimethyl-3-cyclohexenecarboxformaldehyde, 2,2-dimethyl-1,3-dioxan-4,6-dione, 2-pentanone, dibutyl amine, triethylenetetramine, ammonium hydroxide, benzylamine, hydroxycitronellol, cyclohexanone, 2-butanone, pentane dione, dehydroacetic acid, ammonium hydroxide or a mixture thereof. Preferably said non-sulfur-based scavenger is selected from the group consisting of acetoacetamide, ammonium hydroxide and mixtures thereof.

The sulfur-based formaldehyde scavenger is selected from derivatives of sulphate. More particularly it is selected from the group consisting of alkali or alkali earth metal dithionites, pyrosulfites, sulfites, bisulfite, metasulfite, monoalkyl sulphite, dialkyl sulphite, dialkylene sulphite, sulfides, thiosulfates and thiocyanates (e.g. potassium thiocyanate), mercaptans, such as thioglycolic acid, mercaptoethanol, 4-hydroxy-2-mercapto-6-methylpyrimidine, mercaptothiazoline, thiodialkanoic acids, such as thiodipropionic acid, dithiodialkanoic acids, such as 3,3′-dithiodipropionic acid, sulfinates, such as sodium formaldehydesulfoxylate or formamidinosulfinic acid, thiourea or mixtures thereof. Said scavenger activity is preferably pH independent. Preferably said sulfur based scavenger is selected from alkali or alkali earth metal sulfite, bisulfite or mixtures thereof. Most preferably the sulfur-based scavenger is potassium sulfite.

The sulfur-based scavenger according to the present invention is present at a total level, based on total liquid detergent composition weight, of from about 0.001% to about 2.0%, more preferably from about 0.01% to about 0.5%. Where non-sulfur based formaldehyde scavenger is present, it is preferably present in the composition at a total level of about 0.0001% to 1%, more preferably 0.001% to 0.2% based on the liquid detergent composition weight. The ratio of the non-sulfur based scavenger to the sulfur based scavenger, in the liquid detergent composition, is preferably from 0.001:1 to 5:1, more preferably from 0.01:1 to 1:1.

In addition, where acetoacetamide is used as the formaldehyde scavenger, it has been discovered the combination of acetoacetamide and non-polymeric, crystalline, hydroxyl-containing rheology modifier results in discoloration. It has further been discovered that using a combination of an acrylate derivative rheology modifier of formula I, with the non-polymeric, crystalline, hydroxyl-containing rheology modifier, reduces this discoloration.

Suitable droplets can be selected from the group consisting of: silicones, perfumes, cleaning polymers, and mixtures thereof.

Suitable particles include mica, and other powdered insoluble materials. The particles can have volume weighted mean particle size of less than 50 μm. Most preferably the particles have a particle size distribution of from 0.1 μm to 50 μm, more preferably from 0.5 μm to 25 μm and most preferably from 1μm to 20 μm.

As such, the liquid detergent compositions can comprise visible particles, visible bubbles, and combinations thereof, for improved aesthetic appearance. Suitable visible particles and bubbles have a particle size of from 200 microns to 5000 microns, preferably 500 to 2000 microns, measured by means of a Stereo microscope or a an SEM.

The combination of the rheology modifier of formula 1 and a non-polymeric, crystalline, hydroxyl-containing rheology modifier results in a composition having reduced haziness. As such, the compositions of the present invention have a reflectance profile between 0.7 and 10% on average in the visible light spectrum (400 to 700 nm) and a transmittance profile between 48 and 88% on average in the visible light spectrum (400 to 700 nm), more preferably a reflectance profile between 1.5 and 5.9% on average in the visible light spectrum (400 to 700 nm) and a transmittance profile between 64 and 85% on average in the visible light spectrum (400 to 700 nm) and most preferably a reflectance profile between 3.4 and 5.3% on average in the visible light spectrum (400 to 700 nm) and a transmittance profile between 68 and 79% on average in the visible light spectrum (400 to 700 nm), measured while deaerated and before the addition of any particulates. Deaeration can be done using any suitable means.

The liquid laundry composition can comprise additional ingredients for providing improved cleaning to fabrics, or provide other fabric care benefits. Such additional ingredients include those selected from the group consisting of: polymer deposition aid, organic builder and/or chelant, enzymes, enzyme stabiliser, optical brighteners, hueing dyes, particulate material, cleaning polymers, external structurants, and mixtures thereof.

Polymer Deposition Aid: The composition can comprise from 0.1% to 7%, more preferably from 0.2% to 3%, of a polymer deposition aid. As used herein, “polymer deposition aid” refers to any cationic polymer or combination of cationic polymers that significantly enhance deposition of a fabric care benefit agent onto the fabric during laundering. Suitable polymer deposition aids can comprise a cationic polysaccharide and/or a copolymer. “Fabric care benefit agent” as used herein refers to any material that can provide fabric care benefits. Non-limiting examples of fabric care benefit agents include: silicone derivatives, oily sugar derivatives, dispersible polyolefins, polymer latexes, cationic surfactants and combinations thereof. Preferably, the deposition aid is a cationic or amphoteric polymer. The cationic charge density of the polymer preferably ranges from 0.05 milliequivalents/g to 6 milliequivalents/g. The charge density is calculated by dividing the number of net charge per repeating unit by the molecular weight of the repeating unit. In one embodiment, the charge density varies from 0.1 milliequivalents/g to 3 milliequivalents/g. The positive charges could be on the backbone of the polymers or the side chains of polymers.

Organic builder and/or chelant: The composition can comprise from 0.6% to 10%, preferably from 2 to 7% by weight of one or more organic builder and/or chelants. Suitable organic builders and/or chelants are selected from the group consisting of: MEA citrate, citric acid, aminoalkylenepoly(alkylene phosphonates), alkali metal ethane 1-hydroxy disphosphonates, and nitrilotrimethylene, phosphonates, diethylene triamine penta (methylene phosphonic acid) (DTPMP), ethylene diamine tetra(methylene phosphonic acid) (DDTMP), hexamethylene diamine tetra(methylene phosphonic acid), hydroxy-ethylene 1,1 diphosphonic acid (HEDP), hydroxyethane dimethylene phosphonic acid, ethylene di-amine di-succinic acid (EDDS), ethylene diamine tetraacetic acid (EDTA), hydroxyethylethylenediamine triacetate (HEDTA), nitrilotriacetate (NTA), methylglycinediacetate (MGDA), iminodisuccinate (IDS), hydroxyethyliminodisuccinate (HIDS), hydroxyethyliminodiacetate (HEIDA), glycine diacetate (GLDA), diethylene triamine pentaacetic acid (DTPA), catechol sulfonates such as Tiron™ and mixtures thereof.

Enzymes: Suitable enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or combinations thereof. A preferred enzyme combination comprises a cocktail of conventional detersive enzymes such as protease, cutinase and/or cellulase in conjunction with amylase. Detersive enzymes are described in greater detail in U.S. Pat. No. 6,579,839. Suitable enzymes can be freely added, or added in encapsulated form.

Enzyme stabiliser: Enzymes can be stabilized using any known stabilizer system such as calcium and/or magnesium compounds, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly-hexamethylene-bi-guanide or N,N-bis-3-amino-propyl-dodecyl amine or salt; and mixtures thereof.

Optical brighteners: Also known as fluorescent whitening agents for textiles are useful laundering adjuncts. Suitable use levels are from 0.001% to 1% by weight of the fluid laundry detergent composition. Brighteners are for example disclosed in EP 686691B and include hydrophobic as well as hydrophilic types. Brightener 36 and Brightener 49 are preferred for use herein.

Hueing dyes: Hueing dyes, shading dyes or fabric shading or hueing agents are useful laundering adjuncts in fluid laundry detergent compositions. The history of these materials in laundering is a long one, originating with the use of “laundry blueing agents” many years ago. More recent developments include the use of sulfonated phthalocyanine dyes having a Zinc or aluminum central atom; and still more recently a great variety of other blue and/or violet dyes have been used for their hueing or shading effects. See for example WO 2009/087524 A1, WO2009/087034A1 and references therein. The fluid laundry detergent compositions herein typically comprise from 0.00003 wt % to 0.1 wt %, from 0.00008 wt % to 0.05 wt %, or even from 0.0001 wt % to 0.04 wt %, fabric hueing agent.

Perfume: Suitable perfumes are known in the art, and are typical incorporated at a level from 0.001 to 10%, preferably from 0.01% to 5%, more preferably from 0.1% to 3% by weight.

Cleaning polymers: Suitable cleaning polymers provide for broad-range soil cleaning of surfaces and fabrics and/or suspension of the soils. Any suitable cleaning polymer may be of use. Useful cleaning polymers are described in USPN 2009/0124528A1. Non-limiting examples of useful categories of cleaning polymers include: amphiphilic alkoxylated grease cleaning polymers; clay soil cleaning polymers; soil release polymers; and soil suspending polymers.

The liquid detergent composition preferably comprises water. The water content can be present at a level of from 5% to 95%, preferably from 7% to 60%, more preferably from 9% to 50% by weight of the liquid detergent composition.

When used in a water-soluble unit dose article, the water content is preferably at a level of from 3% to 25%, preferably from 5% to 18%, more preferably from 7% to 15% by weight of the liquid detergent composition. Such water-soluble unit dose articles typically comprise the liquid detergent composition, comprised within a compartment formed from water-soluble film.

Suitable water soluble films are known in the art and are typically formed from one or more water-soluble polymers, copolymers or derivatives thereof. Preferred polymers, copolymers or derivatives thereof are selected from the group consisting of: polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof.

Process of Making the Liquid Detergent Composition:

Any suitable means of incorporating the acrylate derivative rheology modifier and the non-polymeric, crystalline, hydroxyl-containing rheology modifier into a liquid detergent composition, or components thereof, can be used.

The rheology modifiers are preferably added after the other ingredients which form the liquid laundry detergent composition, as blending of these ingredients is improved at lower viscosities.

The acrylate derivative rheology modifier can be added individually or as part of a premix.

The non-polymeric, crystalline, hydroxyl-containing rheology modifier is preferably preformed into a premix of the non-polymeric, crystalline, hydroxyl-containing rheology modifier. Any suitable means can be used for incorporating the premix of the non-polymeric, crystalline, hydroxyl-containing rheology modifier into a liquid composition, including static mixers, and through the use of over-head mixers, such as typically used in batch processes.

Preferably, the premix of the non-polymeric, crystalline, hydroxyl-containing rheology modifier is added after the incorporation of ingredients that require high shear mixing, in order to minimise damage to the threads of the premix of the non-polymeric, crystalline, hydroxyl-containing rheology modifier. More preferably, the premix of the non-polymeric, crystalline, hydroxyl-containing rheology modifier is the last ingredient incorporated into the liquid composition. The premix of the non-polymeric, crystalline, hydroxyl-containing rheology modifier is preferably incorporated into the liquid composition using low shear mixing. Preferably, the premix of the non-polymeric, crystalline, hydroxyl-containing rheology modifier is incorporated into the liquid composition using average shear rates of less than 1000 s⁻¹, preferably less than 500 s⁻¹, more preferably less than 200 s⁻¹. The residence time of mixing is preferably less than 20 s, more preferably less than 5 s, more preferably less than 1 s. The shear rate and residence time is calculated according to the methods used for the mixing device, and is usually provided by the manufacturer. For instance, for a static mixer, the average shear rate is calculated using the equation:

$$\dot{γ} = \frac{{v}_{pipe}}{{D}_{pipe}} * {v}_{f}^{- 3 / 2}$$

where:
v_{f} is the void fraction of the static mixer (provided by the supplier)
Dₚᵢₚₑ is the internal diameter of the pipe comprising the static mixer elements
vₚᵢₚₑ is the average velocity of the fluid through a pipe having internal diameter Dₚᵢₚₑ, calculated from the equation:

$${v}_{pipe} = \frac{4 Q}{π {D}_{pipe}^{2}}$$

Q is the volume flow rate of the fluid through the static mixer.

For a static mixer, the residence time is calculated using the equation:

$$residence time = \frac{π {D}_{pipe}^{2} {v}_{f} L}{4 Q}$$

where:
L is the length of the static mixer.

Alternatively, it may be desirable to add the non-polymeric, crystalline, hydroxyl-containing rheology modifier earlier in the manufacturing process to stabilize any non-homogeneity prior to finishing the liquid detergent composition in a late product differentiation process. Thus in some embodiments, the rheology modifiers may be added via a continuous liquid process, whereas in other embodiments, the rheology modifiers may be added via late product differentiation.

Methods:

A) Method of Evaluating the Phase Stability of Fluid Laundry Detergent Compositions:

The phase stability of the composition is evaluated by placing 300 ml of the composition in a glass jar for up to a time period of 21 days at 25° C. we did 12 weeks at 40° C. They are stable to phase splits if, within said time period, (i) they are free from splitting into two or more layers or, (ii) said composition splits into layers, a major layer comprising at least 90%, preferably 95%, by weight of the composition is present.

B) Method of Measuring Yield Stress and Viscosity:

Both parameters are measured using an HAAKE MARS from Thermo Scientific using a 60 mm 1° Cone and a gap size of 52 microns. The yield stress can be obtained by measuring flow curve from 10 (1/s) to 10e⁻⁴ (1/s) and applying Herschel-Bulkley fit: τ=τ₀+K_{γ}ⁿ, where τ is the shear stress, τ₀ is the yield stress, and is γ the shear rate. K and n are fitting parameters. The high shear viscosity at 20 s⁻¹ and low shear viscosity at 0.5 s⁻¹ can be obtained from a logarithmic shear rate sweep from 0.01 s⁻¹ to 1200 s⁻¹ at 20° C.

C) Transmittance/Reflectance Profile:

The Transmittance and Reflectance profile is measured using a Spectrophotometer ColorQuest XE manufactured by HunterLab and calibrated according to the procedure provided by the manufacture. The Hellma type# 700.000-OG vials are filled with representative sample. If necessary, the samples are degassed to remove any bubbles by using an ultrasonic bath (see operating manual for procedure). The Transmittance and Reflectance are measured and full spectrum data between 400 and 700 nm is collected each 10 nm. Then an average of all these data points between 400 and 700 nm is

$${R}_{av} = \frac{{\sum }_{i = 1}^{n} {R}_{i}}{n}$$

$${T}_{av} = \frac{{\sum }_{i = 1}^{n} {T}_{i}}{n}$$

wherein Rₐᵥ is the average Reflectance, Tₐᵥ is the average Transmittance, n is the number of collected data and i each of the data points between 400 and 700 nm.

D) Method of Measuring pH:

The pH is measured, at 25° C., using a Santarius PT-10P pH meter with gel-filled probe (such as the Toledo probe, part number 52 000 100), calibrated according to the instructions manual.

E) Volume-Weighted Particle Size Distribution (PSD):

The volume-weighted particle size distribution (PSD) is determined via single-particle optical sensing (SPOS), also often referred to as optical particle counting (OPC), using the AccuSizer 780 AD instrument and the accompanying software CW788 version 1.82 (Particle Sizing Systems, Santa Barbara, Calif., U.S.A.). The instrument is configured with the following conditions and selections: Sensor Model Number=LE400-05SE; Autodilution=On; Flow Rate=1 ml/sec; Lower Size Threshold=0.50 μm; Collection time=120 sec; Number channels=512; Vessel fluid volume=50 ml; Max coincidence=9200.

F) Nuclear Magnetic Resonance (NMR) Spectrophotometry:

To determine the type of monomers used for copolymerization, and composition of hydrophobically alkali-soluble emulsions (HASE) polyacrylates 2D proton-carbon NMR is used. The 2D experiment is a Hetero-nuclear Single Quantum Coherence (HSQC) experiment where the measurement is carried out in the 1H detected mode via single quantum coherence with proton decoupling in the 13C domain, by using data sets of 2049×256 points. This technique is particularly used for HASE polyacrylate analysis to differentiate overlapping signals in 1H spectra which are due to similar protons bound to different carbons, for example in 1H spectra of HASE polyacrylates the signal for ethyl ester and butyl ester proton falls at δ (ppm)˜4.05 but in 13C spectra distinct peaks are observed corresponding to ethyl and butyl ester.

The HASE polyacrylate samples are prepared in DMSO −d6 (Cambridge Isotopes, Andover, Mass.) solvent with concentration 5 mg/ml. The NMR spectra is acquired at Bruker NMR spectrophotometer operating at 600 MHz equipped with cryo probe.

The area under the signal is proportional to the number of protons that signal corresponds to.

The molar composition is determined by comparing the integral intensities of corresponding groups in the 1D and/or 2D NMR spectrum. It is important to realize that the compositional information represents a global average and provides no details regarding the compositional heterogeneity within the population of polymer chains.

On the one hand, R₁, R₃, R₅ and R₇ molar percentage is determined by integrating the area for the hydrogens corresponding to the acrylate and methacrylate groups:

$$\% mol H = \frac{{A}_{H} \times 100}{( {A}_{H} + \frac{{A}_{{CH}_{3}}}{3} )} ; \% mol {CH}_{3} = \frac{\frac{{A}_{{CH}_{3}}}{3} \times 100}{( {A}_{H} + \frac{{A}_{{CH}_{3}}}{3} )}$$

On the other hand, R₂, R₄, R₆ and R₈ molar percentage is determined by integrating the area for the hydrogens corresponding to the different monomers respective:

$$\% mol {R}_{i} = \frac{\frac{{A}_{{H}_{i}}}{{n°H}_{i}} \times 100}{\sum \frac{{A}_{{H}_{i}}}{n° {H}_{i}}}$$

being Rᵢ equal to R₂, R₄, R₆ or R₈ and Hᵢ the corresponding Hydrogens associated to them.

In the case of R₂, R₄, R₆ being a carboxylic acid group, molar percentage is determined by the difference between the —CH₂— groups from the main carbon chain and the other monomers.

$$\% mol COOH = ( \frac{{A}_{{CH}_{2}}}{2} - \frac{\frac{{A}_{{H}_{i}}}{n° {H}_{i}}}{\sum \frac{{A}_{{H}_{i}}}{n° {H}_{i}}} ) \times 100$$

### EXAMPLES

The following examples were made by simple mixing, as is known in the art:

| | Comparative | Comparative | Comparative | | |
|---|---|---|---|---|---|
| | example 1 | example 2 | example 2 | Example A | Example B |
| | wt % | wt % | wt % | wt % | wt % |
| Sodium hydroxide | 3.7 | 3.7 | 3.7 | 3.7 | 3.7 |
| 1,2-Propanediol | 2.8 | 2.8 | 2.8 | 2.8 | 2.8 |
| Citric Acid | 3.2 | 3.2 | 3.2 | 3.2 | 3.2 |
| sodium cumene | 0.9 | 0.9 | 0.9 | 0.9 | 0.9 |
| sulfonate | | | | | |
| Linear alkyl benzene | 10 | 10 | 10 | 10 | 10 |
| sulfonic acid | | | | | |
| C12-45 alkyl-7- | 4.4 | 4.4 | 4.4 | 4.4 | 4.4 |
| ethoxylated | | | | | |
| C₁₂₋₁₈ Fatty acid | 3.1 | 3.1 | 3.1 | 3.1 | 3.1 |
| Soil suspending | 1 | 1 | 1 | 1 | 1 |
| alkoxylated | | | | | |
| polyalkylenimine | | | | | |
| polymer¹ | | | | | |
| Amphiphilic | 0.4 | 0.4 | 0.4 | 0.4 | 0.4 |
| alkoxylated grease | | | | | |
| cleaning polymer² | | | | | |
| Monoethanolamine: | 2.6 | 2.6 | 2.6 | 2.6 | 2.6 |
| C₁₂₋₁₄ EO•3•SO₃H | | | | | |
| Hydrogenated castor oil | 0.4 | 0 | 0.4 | 0.4 | 0.1 |
| Alcogum ® L 15 | 0 | 0 | 0.4 | 0 | 0 |
| Novethix ™ HC200 | 0 | 1 | 0 | 0.4 | 0.2 |
| Minors (preservatives, | up to 2% | up to 2% | up to 2% | up to 2% | up to 2% |
| stabilizers, solvents . . . ) | | | | | |
| Buffers | to pH 8 | to pH 8 | to pH 8 | to pH 8 | to pH 8 |
| (monoethanolamine) | | | | | |
| Water | up to 100% | up to 100% | up to 100% | up to 100% | up to 100% |
| Dynamic yield stress | 0.34 | below 0.001 | 0.4 | 1.64 | 0.28 |
| (Pa) | | | | | |
| Transmittance (Tₐᵥ) | 48.24 | — | — | — | 79.09 |
| Reflectance (Rₐᵥ) | 9.96 | — | — | — | 3.43 |

¹600 g/mol molecular weight polyethylenimine core with 24 ethoxylate groups per —NH and 16 propoxylate groups per —NH. Available from BASF (Ludwigshafen, Germany)
²PG617 or PG640 (BASF, Germany)

Comparative example 1 shows the suspension power when only a non-polymeric, crystalline, hydroxyl-containing rheology modifier such as hydrogenated castor oil is used. Moreover, comparative example 2 shows that there is no substantially measurable suspension power when using the acrylate derived rheology modifier alone.

Comparative example 3, shows an acrylate rheology modifier derivative without R₈ moiety, and therefore without a synergy with the non-polymeric, crystalline, hydroxyl-containing rheology modifier. There is no significant difference in the dynamic yield stress measured versus comparative example 1.

Example A shows that by adding 0.4% of the acrylate derived rheology modifier to comparative example 1, suspension power is increased almost 5 times.

Example B shows that the amount of non-polymeric, crystalline, hydroxyl-containing rheology modifier such as hydrogenated castor oil can be substantially reduced (from 0.4% wt to 0.1% wt) by the addition of a small amount of the acrylate derived rheology modifier (0.2)% maintaining the suspension power of comparative example 1.

The following examples were made by simple mixing, as known in the art:

| | Example C | Example D | Example E | Example F | Example G |
|---|---|---|---|---|---|
| | wt % | wt % | wt % | wt % | wt % |
| Sodium hydroxide | 3.7 | 3.7 | 3.7 | 3.7 | 0 |
| 1,2-Propanediol | 2.8 | 3 | 2.8 | 3 | 6 |
| Citric Acid | 3.2 | 2.8 | 3.2 | 3.2 | 3.2 |
| sodium cumene | 0.9 | 1 | 0.9 | 0 | 0 |
| sulfonate | | | | | |
| Linear alkyl benzene | 9.9 | 9 | 9.9 | 4.4 | 5.6 |
| sulfonic acid | | | | | |
| C12-45 alkyl-7- | 4.4 | 6.8 | 4.4 | 5.2 | 6 |
| ethoxylated | | | | | |
| C₁₂₋₁₈ Fatty acid | 3.1 | 2.8 | 3.1 | 2 | 3.1 |
| Soil suspending | 1 | 1 | 1 | 0 | 0.2 |
| alkoxylated | | | | | |
| polyalkylenimine | | | | | |
| polymer¹ | | | | | |
| Amphiphilic | 0.4 | 0.4 | 0.4 | 0.5 | 2 |
| alkoxylated grease | | | | | |
| cleaning polymer² | | | | | |
| Monoethanolamine: | 2.6 | 4.2 | 2.6 | 10.2 | 8 |
| C₁₂₋₁₄ EO•3•SO₃H | | | | | |
| Protease | 1.5 | 1.5 | 1.5 | 1 | 0.7 |
| Amylase | 0.7 | 0 | 0.7 | 0.4 | 0.2 |
| mannanase | 0.1 | 0 | 0.1 | 0 | 0 |
| xyloglucanase | 0.1 | 0 | 0.1 | 0 | 0 |
| pectate lyase | 0.4 | 0 | 0.4 | 0.4 | 0 |
| Hydrogenated castor oil | 0.2 | 0.18 | 0.4 | 0.2 | 0.5 |
| Novethix HC200 | 0.1 | 0.15 | 0 | 0.2 | 0.4 |
| Rheovis AT120 | 0 | 0 | 0.4 | 0 | 0 |
| Perfume | 0 | 0.4 | 0.5 | 0.5 | 0.4 |
| Minors (preservatives, | up to 2% | up to 2% | up to 2% | up to 2% | up to 2% |
| stabilizers, solvents, | | | | | |
| brighteners . . . ) | | | | | |
| buffers | to pH 8 | to pH 8 | to pH 8 | to pH 8 | to pH 8 |
| (monoethanolamine) | | | | | |
| Water | up to 100% | up to 100% | up to 100% | up to 100% | up to 100% |

¹600 g/mol molecular weight polyethylenimine core with 24 ethoxylate groups per —NH and 16 propoxylate groups per —NH. Available from BASF (Ludwigshafen, Germany)
²PG617 or PG640 (BASF, Germany)

Further examples of the present invention are as follows:

| | Example H |
|---|---|
| | wt % |
| 1,2-Propanediol | 15 |
| Monoethanolamine | 10 |
| Glycerol | 5 |
| Hydroxyethane diphosphonic acid | 1 |
| Potassium sulfite | 0.2 |
| C12-45 alkyl 7-ethoxylate | 20 |
| Linear Alkylbenzene sulfonic acid | 24.5 |
| FWA | 0.2 |
| C12-18 Fatty Acid | 16 |
| Ethoxysulfated Hexamethylene Diamine | 2.9 |
| Dimethyl Quat | |
| Soil Suspending Alkoxylated Polyalkylenimine | 1 |
| Polymer¹ | |
| magnesium chloride | 0.2 |
| Hydrogenated castor oil | 0.08 |
| Novethix ™ HC200 | 0.1 |
| Water and minors | Up to 100% |

¹600 g/mol molecular weight polyethylenimine core with 24 ethoxylate groups per —NH and 16 propoxylate groups per —NH. Available from BASF (Ludwigshafen, Germany)

| | I | J |
|---|---|---|
| | wt % | wt % |
| sodium hydroxide | 3.6 | 3.6 |
| 1,2-Propanediol | 4.4 | 4.4 |
| Ethanol | 0.9 | 0.9 |
| Citric Acid | 3.2 | 3.2 |
| Linear alkyl benzene sulfonic acid | 7 | 7 |
| C12-45 alkyl-7-ethoxylated | 4 | 4 |
| C₁₂₋₁₈ Fatty acid | 4 | 4 |
| Soil Suspending Alkoxylated | 0.3 | 0.3 |
| Polyalkylenimine Polymer¹ | | |
| Monoethanolamine: C₁₂₋₁₄ | 6.9 | 6.9 |
| EO•3•SO₃H | | |
| Perfume | 0.4 | 0.3 |
| Perfume microcapsules slurry² | 1.2 | — |
| Perfume microcapsules slurry³ | — | 1.8 |
| Hydrogenated castor oil | 0.1 | 0.1 |
| Novethix ™ HC200 | 0.1 | 0.1 |
| Minors (preservatives, stabilizers, | up to 2% | up to 2% |
| solvents, brighteners . . . ) | | |
| buffers (monoethanolamine) | To pH 8 | To pH 8 |
| Water | up to 100% | up to 100% |

¹ 600 g/mol molecular weight polyethylenimine core with 24 ethoxylate groups per —NH and 16 propoxylate groups per —NH. Available from BASF (Ludwigshafen, Germany)
² Suitable perfume microcapsules for use in this composition (which can be purchased from Appvion Inc, 825 East Wisconsin Ave, Appleton, WI 54911), are made as follows: 25 grams of butyl acrylate-acrylic acid copolymer emulsifier (Colloid C351, 25% solids, pka 4.5-4.7, (Kemira Chemicals, Inc. Kennesaw, Georgia U.S.A.) is dissolved and mixed in 200 grams deionized water. The pH of the solution is adjusted to pH of 4.0 with sodium hydroxide solution. 8 grams of partially methylated methylol melamine resin (Cymel 385, 80% solids, (Cytec Industries West Paterson, New Jersey, U.S.A.)) is added to the emulsifier solution. 200 grams of perfume oil is added to the previous mixture under mechanical agitation and the temperature is raised to 50° C. After mixing at higher speed until a stable emulsion is obtained, the second solution and 4 grams of sodium sulfate salt are added to the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.8, 25 grams of partially methylated methylol melamine resin (Cymel 385, 80% solids, Cytec). This mixture is heated to 85° C. and maintained overnight with continuous stirring to complete the encapsulation process. A volume-mean particle size of 18 microns is obtained.
³86 wt % core/14 wt % wall Melamine Formaldehyde (MF) perfume microcapsule coated with a polyvinylformamide deposition aid

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent composition comprising:
a) a non-polymeric, crystalline, hydroxyl-containing rheology modifier;
b) an acrylate derivative rheology modifier of formula I: 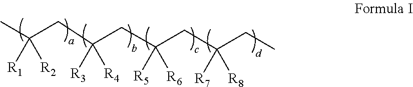
wherein:
i. a, b, c and d are integers from about 0 to about 4,000 and the sum of all integers in rheology modifier 1 is an integer from about 60 to about 7,000;
ii. Rᵢ, R₃, R₅ and R₇ are independently selected from the group consisting of: —H, —CH₃
iii. R₈ is a ester moiety having the formula 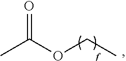
wherein f is an integer from 3 to 7;
iv. R₂, R₄ and R₆ are independently selected from the group consisting of: 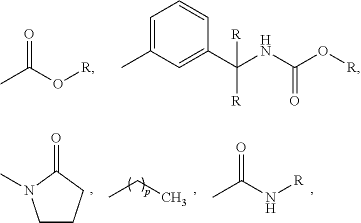
wherein p is an integer from about 0 to about 45, and R is independently selected from the group consisting of: 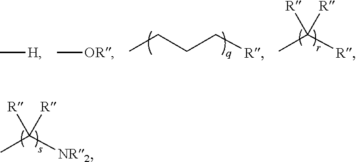
wherein each q and r and s is independently an integer from about 0 to about 45, and each R″ is independently selected from the group consisting of: 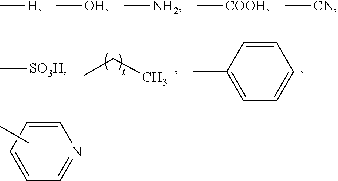
wherein t is an integer from about 0 to about 40; and
v. the polymeric structuring agent has a molecular weight of from about 50,000 Da to about 2,000,000 Da;
and acrylate derivative rheology modifier comprises at least about 30% by mol of R₈;
c) Surfactant; and
d) water.

2. The composition according to claim 1, wherein polymeric structuring agent has a molecular weight of from about 500,000 Da to 900,000 Da.

3. The composition according to claim 1, wherein R₂, R₄ and R₆ are 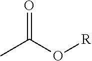
wherein R is independently selected from the group consisting of: 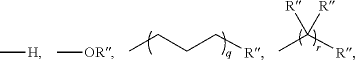
wherein each q and r and s is independently an integer from about 0 to about 45 and each R″ is independently selected from the group consisting of: 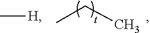
wherein t is an integer from about 0 to about 40.

4. The composition according to claim 3, wherein R is independently selected from the group consisting of: 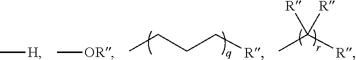
wherein each q and r and s is independently an integer from about 20 to about 35, and each R″ is independently selected from the group consisting of: 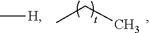
wherein t is an integer from about 1 to about 20.

5. The composition according to claim 1, wherein the non-polymeric, crystalline, hydroxyl-containing structuring agent is present at a level of from about 0.01 wt % to about 1.0 wt % of the composition.

6. The composition according to claim 5, wherein the non-polymeric, crystalline, hydroxyl-containing structuring agent is present at a level of from about 0.10 wt % to about 0.50 wt % of the composition.

7. The composition according to claim 1, wherein the non-polymeric, crystalline, hydroxyl-containing structuring agent is hydrogenated castor oil.

8. The composition according to claim 1, wherein the acrylate derivative rheology modifier is present at a level of from about 0.01 wt % to about 1.2 wt % of the composition.

9. The composition according to claim 8, wherein the acrylate derivative rheology modifier is present at a level of from about 0.10 wt % to about 0.5 wt % of the composition.

10. The composition according to claim 1, wherein the acrylate derivative rheology modifier comprises less than about 30% by mol of carboxylic acid groups as R₂, R₄ and/or R₆.

11. The composition according to claim 1, wherein the acrylate derivative rheology modifier comprises at least about 40% by mol of R₈.

12. The composition according claim 11, wherein R₈ is a butyl ester group (f=about 3).

13. The composition according to claim 1, wherein the acrylate derivative rheology modifier comprises less than about 50% by mol of ethyl ester groups as R₂, R₄ and/or R₆.

14. The composition according to claim 13, wherein the acrylate derivative rheology modifier comprises less than about 30% by mol of ethyl ester groups as R₂, R₄ and/or R₆.

15. The composition according to claim 1, wherein the surfactant is selected from the group consisting of: anionic surfactant, non-ionic surfactant, and mixtures thereof.

16. The composition according to claim 1, wherein the surfactant is present at a level of from about 1 wt % to about 70 wt % of the composition.

17. The composition according to claim 1, wherein the composition further comprises particles, microcapsules, core-shell capsules, droplets, bubbles, and mixtures thereof.

18. The composition according to claim 17, wherein the composition comprises microcapsules, the microcapsules comprising a shell, said shell comprising melamine-formaldehyde, an acrylate derived polymer and/or multifunctional acrylates, polyamide, polyurea, polyurethane, polycarbonates, polyvinyl alcohol, acetals (such as 1,3,5-triol-benzene-gluteraldehyde and 1,3,5-triol-benzene melamine), starch, cellulose acetate phthalate and mixtures thereof.

19. The composition according to claim 13, wherein the microcapsules comprise a deposition aid.

20. The use of a combination of a non-polymeric, crystalline, hydroxyl-containing rheology modifier and an acrylate derivative rheology modifier of formula I to provide a composition, particularly a laundry detergent composition, having improved translucency.
